(19) United States
(12) Patent Application Publication
(10) Pub. No.: US 2025/0025358 A1
(43) Pub. Date: Jan. 23, 2025

(54) ALTERNATING PRESSURE BED

(71) Applicant: Ha Van Vo, Macon, GA (US)

(72) Inventor: Ha Van Vo, Macon, GA (US)

(21) Appl. No.: 17/803,193

(22) Filed: Oct. 15, 2021

(51) Int. Cl. A61G 7/057; A61G 7/05; A61H 15/00

(52) U.S. Cl. CPC A61G 7/05707; A61G 7/0573; A61H 15/0078; A61G 7/0527; A61H 2015/0021; A61H 2201/0146; A61H 2201/123; A61H 2201/1246; A61H 2201/1695; A61H 2209/00; A61H 2230/805

(57) ABSTRACT

An alternating pressure bed includes first and second sets of closely spaced rollers mounted in a roller frame to be mutually parallel and co-planar along a preferably horizontal plane and each being rotatable about its individual longitudinal axis, and a first drive mechanism for rotating each of the rollers in the first set in a clockwise direction and a second drive mechanism for rotating each of the rollers in the second set in a counter-clockwise direction. A mattress shielding sheet extends across and rests on the rollers, and a mattress extends across and rests on the mattress shielding sheet. Each roller has at least one surface protrusion, so that when the roller is rotated the protrusion applies alternating and varying upward pressure through the mattress.

### FILING HISTORY

This application continues from provisional patent application No. 63/092,298 filed on Oct. 15, 2020, the contents of which are incorporated herein by reference.

### BACKGROUND OF THE INVENTION

### 1. Field of the Invention

The present invention relates generally to the field of therapeutic beds. More specifically, the present invention relates to a bed having a mattress and a mechanism for continually varying the relative level of pressure of the mattress against a person lying on the mattress from one region of contact to another, to prevent prolonged high pressure against fixed areas that can hinder blood circulation and lead to ailments such as pressure sores. The bed includes first and second sets of closely spaced rollers mounted in a roller frame to be mutually parallel and co-planar along a preferably horizontal plane and each rotatable about its individual longitudinal axis, and a first drive mechanism for rotating each of the rollers in the first set in a clockwise direction and a second drive mechanism for rotating each of the rollers in the second set in a counter-clockwise direction. A mattress shielding sheet extends across and rests on the rollers, and a mattress extends across and rests on the mattress shielding sheet. Each roller has at least one surface protrusion, so that when the roller is rotated the protrusion applies alternating and varying upward pressure against the mattress shielding sheet and therefore against the mattress and a person resting on the mattress. The preferred surface protrusion is a spiral extending longitudinally along the roller outer surface in the configuration of a screw thread. The spiral preferably is formed of a wire wrapped in a spiral configuration around and affixed to the roller surface, extending substantially from a first longitudinal end of the given roller to the second longitudinal end.

To provide additional shifting of pressure points created by the roller radial protrusions, a roller set separation mechanism preferably is provided which laterally moves the first and second roller sets away from each other and then back toward each other and together while remaining in their common, horizontal plane.

### 2. Description of the Prior Art

There have long been beds which have mechanisms for raising the head or foot area of the mattress for user comfort. These prior beds are not effective in preventing pressure sores and related ailments of patients confined to beds, who cannot readily change their position to relieve the effects of prolonged mattress pressure at various points on their body.

It is thus an object of the present invention to provide an alternating pressure bed which automatically shifts mattress pressure points on the patient body to other points.

It is another object of the present invention to provide such a bed which includes rollers underneath the mattress having one or more roller protrusions, and means for rotating these rollers to shift the positions of the protrusions to shift the primary body support points of the mattress, and thus prevent prolonged pressure at any particular points on the patient body.

It is still another object of the present invention to provide such a bed which additionally includes a mechanism for laterally separating two or more groups of these rotating rollers to further shift mattress pressure points on the patient body.

It is yet another object of the present invention to provide such a bed which includes a mattress shielding sheet between the mattress and the rollers to prevent the rollers and their protrusions from causing undue wear to the mattress, and a mattress thin enough to readily transmit roller protrusion pressure from the roller protrusions to the patient body, and which is optionally computer controlled.

It is a further object of the present invention to provide a weight measuring mattress elevating assembly which detects the weight of each patient and compensates for weight differences among patients by raising or lowering the mattress relative to rollers a distance corresponding to the weight detected, so that the roller radial protrusions apply similar and appropriate levels of pressure or force against the body of the patient regardless of their weight.

It is finally an object of the present invention to provide such a bed which is sturdy, reliable, durable, easy to operate and relatively inexpensive to manufacture.

### SUMMARY OF THE INVENTION

The present invention accomplishes the above-stated objectives, as well as others, as may be determined by a fair reading and interpretation of the entire specification.

An alternating pressure bed is provided, including first and second sets of closely spaced rollers mounted in a roller frame to be mutually parallel and co-planar along a preferably horizontal plane and each being rotatable about its individual longitudinal axis, and a first drive mechanism for rotating each of the rollers in the first set in a clockwise direction and a second drive mechanism for rotating each of the rollers in the second set in a counter-clockwise direction. A mattress shielding sheet extends across and rests on the rollers, and a mattress extends across and rests on the mattress shielding sheet. Each roller has at least one surface protrusion, so that when the roller is rotated the protrusion applies alternating and varying upward pressure against the mattress shielding sheet and therefore against the mattress and a person resting on the mattress. The preferred surface protrusion has a spiral configuration, and takes the form of a wire wrapped around and affixed to the roller surface.

### BRIEF DESCRIPTION OF THE DRAWINGS

Various other objects, advantages, and features of the invention will become apparent to those skilled in the art from the following discussion taken in conjunction with the following drawings, in which:

FIG. 1 is a partially exploded upper perspective view of the preferred embodiment of the present alternating pressure bed, showing the mattress separated and elevated from the remainder of the bed, revealing the roller frame, rollers and roller radial protrusions.

FIG. 2 is another view as in FIG. 1, showing an end of the bed and an end panel, and a set of roller sprockets.

FIG. 3 is a cross-sectional end view of the rollers illustrating the first and second roller sets.

FIG. 4 is a cross-sectional end view of the rollers, showing the flexible mattress shielding sheet on top of the rollers partially conforming to the roller shapes.

FIG. 5 is a view as in FIG. 4 except that the mattress is shown on top of the mattress shielding sheet, and a representation of a patient is shown resting on top of the mattress.

FIG. 6 is a perspective upper view of a first end of the roller frame, rollers, first end panel and first end plate with sprockets and the first drive belt.

FIG. 7 is a perspective upper view of a second end of the roller frame, rollers, second end panel and second end plate with sprockets and the second drive belt.

FIG. 8 is a side perspective view of the present bed showing a linear actuator, the second motor and the bed caster wheels.

FIG. 9 is another side perspective view of the present bed.

FIG. 10 is a separate side perspective view of the roller frame and rollers, first and second end panels, bed floor and carriage wheel assemblies.

FIG. 11 is an upper, side perspective view of the roller frame with the rollers and end panels removed, showing the carriage rail channels on the bed floor.

FIG. 12 is an upper, end perspective view as in FIG. 7 with the roller frame removed.

FIG. 12A is an upper, end perspective view of the first and second carriages and their respective set of rollers.

FIG. 13 is a perspective view similar to that of FIG. 1 but showing schematically the mattress elevating assembly at each of the four corners of the roller frame.

FIG. 14 is a perspective side view similar to that of FIG. 8 but once again showing the mattress elevating assembly.

FIG. 15 is a view as in FIG. 14 but with mattress lifted above the mattress frame.

FIG. 16 is partial, upper perspective view of the roller frame, mattress frame and one of the four load cell mattress linear actuators, revealing the interior of the mattress frame and the security banks forming the bottom of the mattress frame for supporting the mattress.

FIG. 17 is a side view of one of the mattress linear actuators.

FIG. 18 is a front view of one of the mattress linear actuators as in FIG. 17.

FIG. 19 is a perspective view of a what is referred to both as a load sensor and a load sensor.

### DETAILED DESCRIPTION OF THE PREFERRED EMBODIMENTS

As required, detailed embodiments of the present invention are disclosed herein; however, it is to be understood that the disclosed embodiments are merely exemplary of the invention which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Reference is now made to the drawings, wherein like characteristics and features of the present invention shown in the various FIGURES are designated by the same reference numerals.

### First Preferred Embodiment

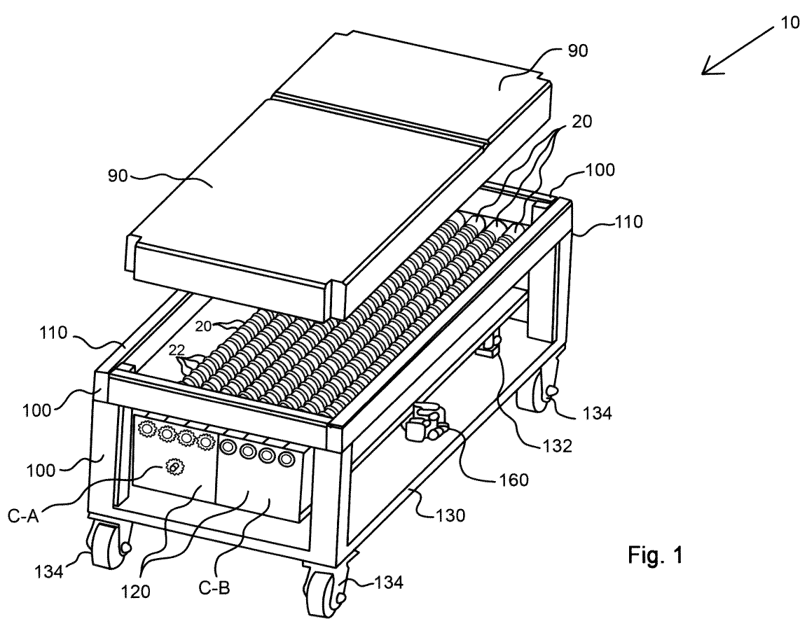

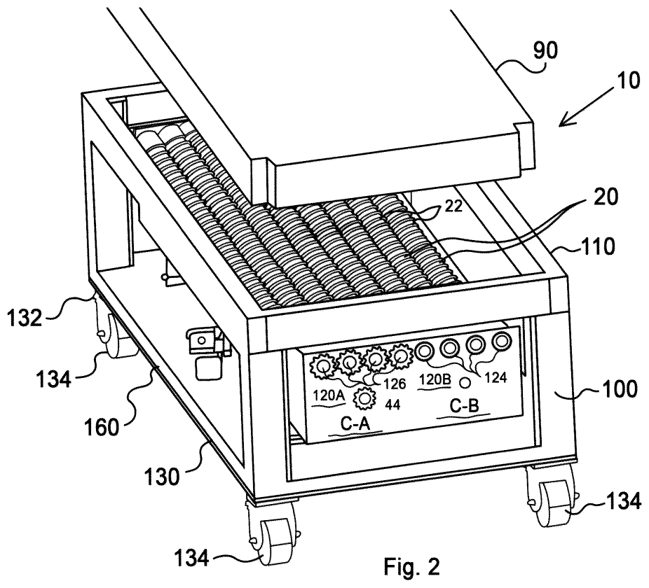

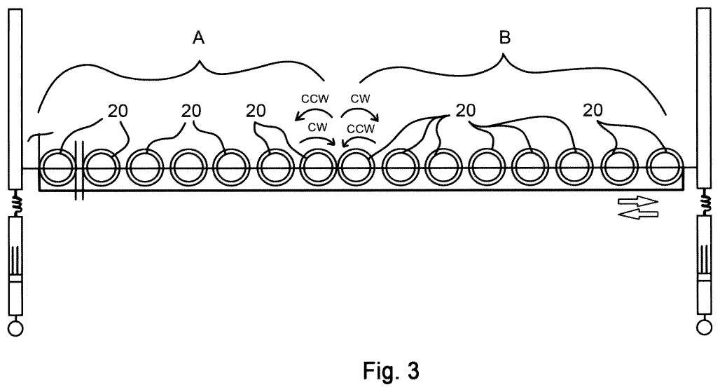

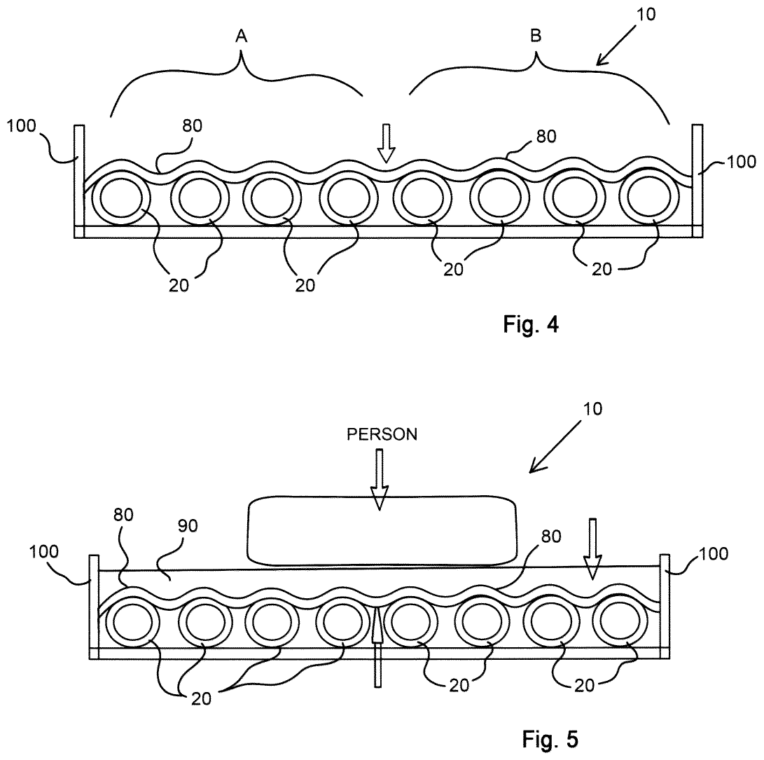

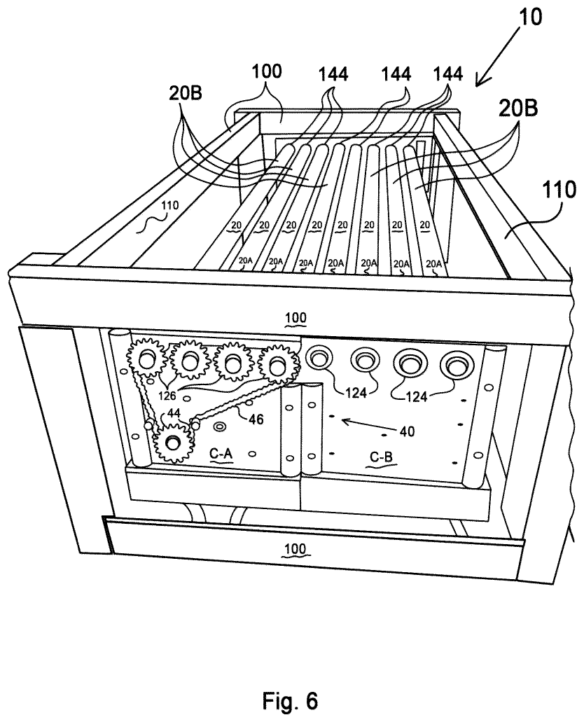

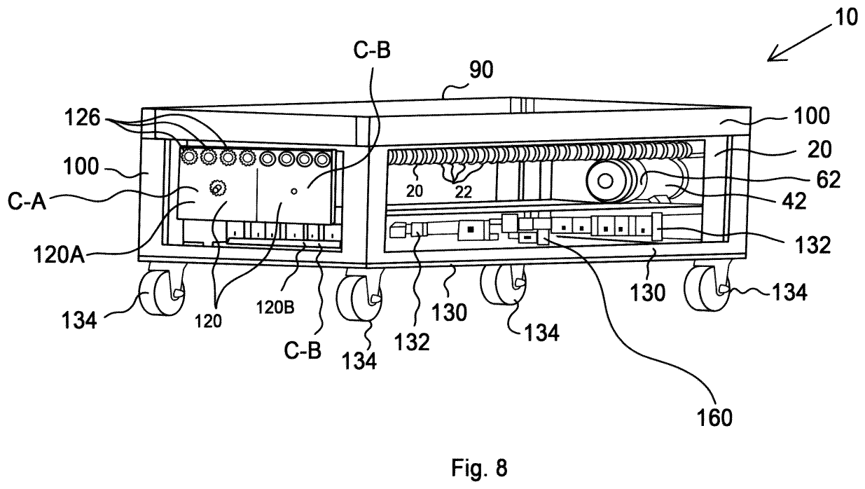

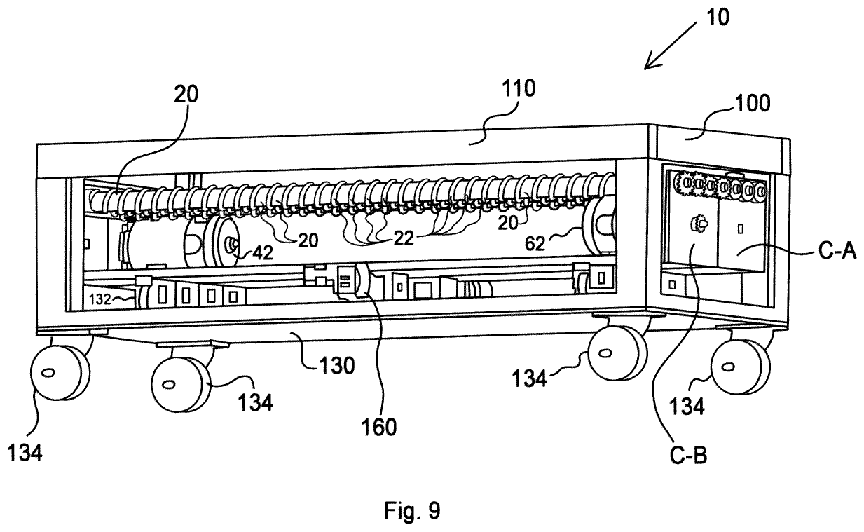

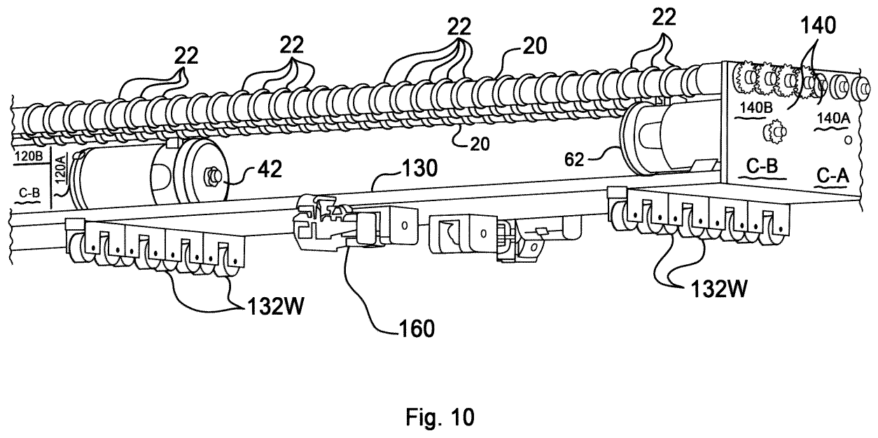

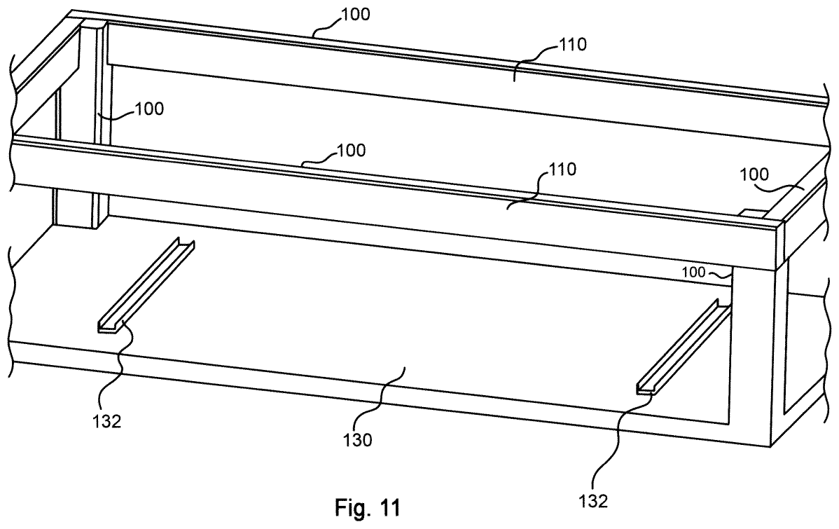

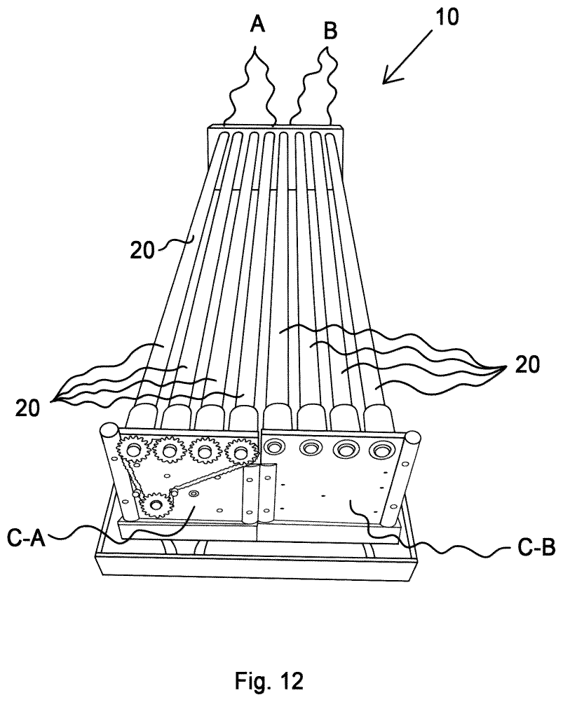

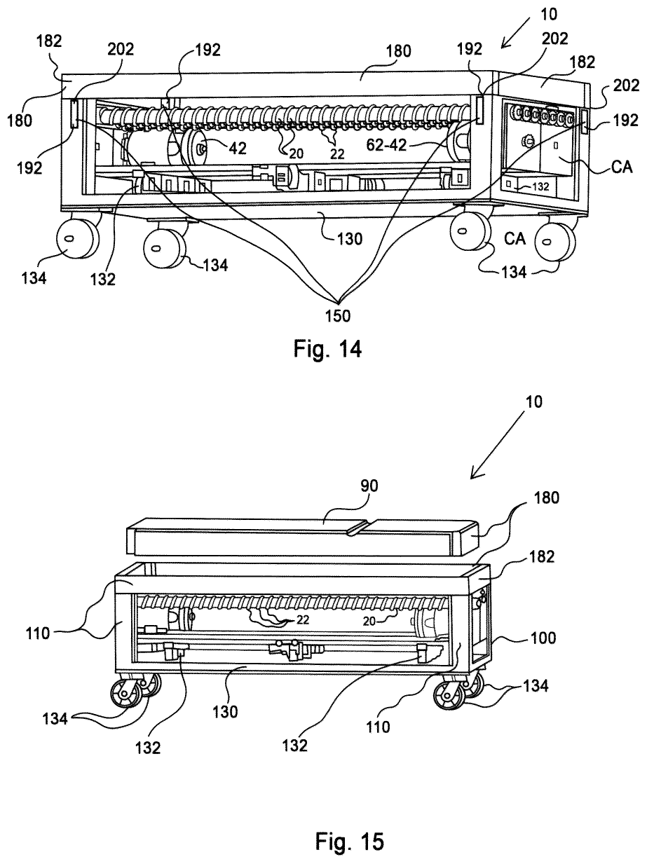

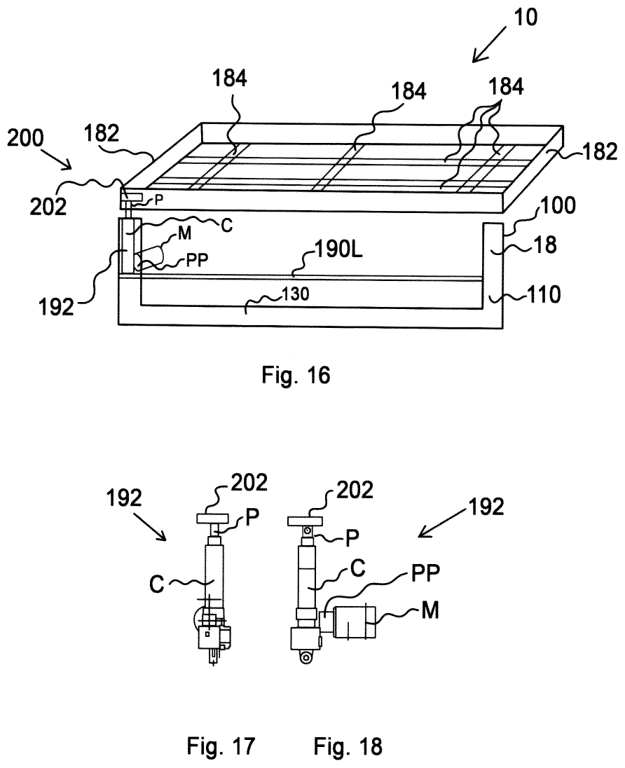

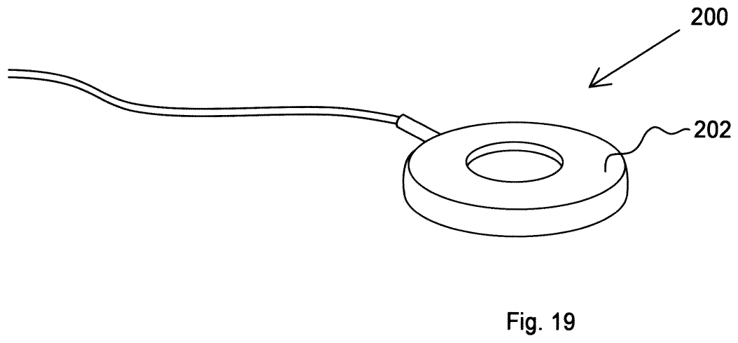

Referring to FIGS. 1-19, an alternating pressure bed 10 is disclosed including a series of rollers 20 of a first roller set A and a second roller set B, both roller sets A and B being mounted in a roller frame 100 to be mutually parallel and co-planar along a preferably horizontal plane and to be rotatable about its individual longitudinal axis. The bed 10 further includes a first drive mechanism 40 for rotating each of the rollers 20 in the first roller set A in a first rotational direction, such as clockwise direction and a second drive mechanism 60 for rotating each of the rollers 20 in the second roller set in a second rotational direction, such as counter-clockwise direction. A mattress shielding sheet 80 extends across and rests on the rollers 20 of roller sets A and B, and a mattress 90 extends across and rests on the mattress shielding sheet 80. Each roller 10 has at least one radial surface protrusion referred to hereinafter as a radial protrusion 22, so that when the roller 20 is rotated the protrusion applies alternating and varying upward pressure against the mattress shielding sheet 80 and therefore against the mattress 90 and a person resting on the mattress 90.

The preferred surface protrusion 22 takes the form of a spiral extending longitudinally along the roller outer surface 20S in the configuration of a screw thread. The spiral preferably is formed of a wire 24 wrapped in a spiral configuration around and fastened to the roller outer surface 20S, extending substantially from a first longitudinal roller end 20A of the given roller 20 to the second longitudinal roller end 20B.

The mattress shielding sheet 80 must be highly flexible and the mattress 90 must be comparatively thin relative to conventional mattresses, so that alternating pressure caused by the rotation of the roller surface protrusions 20S can be transmitted to a person resting on the mattress 90. A preferred shielding sheet 80 material is a durable or artificial rubber, although other materials are contemplated. The shielding sheet 80 preferably is thin and readily flexible, and the mattress 90 thin relative to most commercially available mattresses and is formed of a relatively non-compressible or minimally compressible material, so that rotating roller surface protrusion 20S pressure variations are not entirely absorbed by the mattress 90 and are therefore transmitted to the body of a person resting on the mattress 90.

The rollers 20 preferably all rotate at the same speed, even though the first and second roller sets A and B respectively rotate at this speed in opposite directions. The roller 20 speed is controlled by the user health care professional and can be set and subsequently altered, either mechanically or by operation of a computer (not shown), to meet the varying, individual needs of specific patients.

The roller frame 100 preferably includes a first end plate 122 mounted to a first end panel 120, a second end plate 142 mounted to a second end panel 140, and structural interconnecting members 110 interconnecting and holding upright the first and second end panels 120 and 140. The rollers 20 of the first roller set A each pass through a hole in the first end plate 122 fitted with a tubular first end plate bearing 124, so that each given roller first end 20A protrudes from the first end plate 122 and is fitted with a first set roller sprocket 126. The first roller set A rollers 20 each pass through a hole in the second end plate 142 fitted with a tubular second end plate bearing 146, so that the rollers 20 of the first roller set A can all rotate smoothly and freely.

The first drive mechanism 40 for driving the rollers 20 of the first roller set A includes the first set roller sprockets 126 and a first motor 42 mounted to the first end panel 120, having a first motor drive shaft 42D passing through a drive shaft hole (SHOWN??) in the first end panel 120 to protrude from the outward side of the first end panel 120, the protruding drive shaft 42D is fitted with a first drive shaft sprocket 44. An internally notched first drive belt 46 wraps engagingly around the first set roller sprockets 126 and the first drive shaft sprocket 44, so that activation of the first motor causes the first motor to rotate and drive the first drive belt 46 and therefore the first set roller sprockets 44 and all of the rollers 20 of the first roller set A in the same rotational direction. The first drive mechanism 40 optionally further includes a first transmission (not shown) drivably interconnecting the first motor drive shaft 42D and the first drive belt 46.

By the same token, the rollers 20 of the second roller set B each pass through a hole in the second end plate 140 fitted with a corresponding tubular second end plate bearing 144, so that each given roller second end 20B protrudes from the second end plate 142 and is fitted with a second set roller sprocket 146. The second roller set rollers 20 each pass through a hole in the first end plate 122 fitted with a tubular first end plate bearing 124, so that the rollers 20 of the second roller set B can all rotate smoothly and freely.

The second drive mechanism 60 for driving the rollers 20 of the second roller set includes the second set roller sprockets 146 and a second motor 62 mounted to the second end panel 140, having a second motor drive shaft 62D passing through a drive shaft hole in the second end panel 140 to protrude from the second end panel 140, the protruding drive shaft 62D being fitted with a second drive shaft sprocket 64. An internally notched second drive belt 66 wraps engagingly around the second set roller sprockets 146 and the second drive shaft sprocket 64, so that activation of the second motor 62 causes the second motor 62 to rotate and drive the second drive belt 66 and therefore the second set roller sprockets 146 and all of the rollers 20 of the second set B in the same rotational direction, opposite that of the first roller set A. The second drive mechanism 60 optionally further includes a second transmission (not shown) drivably interconnecting the second motor drive shaft 62D and the second drive belt 66.

The first and second motors 42 and 62 are controlled by the user through operation of a control panel (not shown) which controls electric power reaching the first and second motors 42 and 62. The control panel, which once again may include a computer (not shown), preferably controls not only whether the first and second motors 42 and 62 are on or off, but also controls the speed of the first and second motor drive shafts 42D and 62D and thus the speeds of the rollers 20 of the first and second roller sets A and B. The first and second transmissions are controlled through operation of the control panel.

To provide additional shifting of pressure points created by the roller radial protrusions 22, a roller set separation mechanism 150 preferably is provided which laterally moves first and second roller sets A and B away from each other and then back toward each other and together while remaining in their common, horizontal plane. To make this possible, first end panel 120 is divided into first end panel first section 120A and first end panel second section 120B which are separable from each other, and first end plate 122 is divided into first end plate first section 122A and first end plate second section 122B, which also are separable from each other. By the same token, second end panel 140 is divided into second end panel first section 140A and second end panel section 140B which are separable from each other, and second end plate 142 is divided into second end plate first section 142A and second end plate second section 142B, which also are separable from each other.

The first end panel first section 120A and second end panel first section 140A, first end plate first section 122A and second end plate first section 142A, and the corresponding first roller set A and first motor 42 that they retain, are mounted to a first carriage C-A. First carriage C-A has carriage wheel assemblies 132W which ride in parallel and spaced apart carriage rail channels 132 on the bed floor 130 so that first carriage C-A can ride laterally. (As illustrated, it is preferred that the bed floor 130 is mounted on caster wheels 134.

The first end panel second section 120B and the second end panel section 140B, first end plate second section 122B and second end plate second section 142B, and the corresponding second roller set B and second motor 62 that they retain, are mounted to a second carriage C-B. Second carriage has carriage wheel assemblies 132W which also ride in carriage rail channels 132 on the bed floor 130 so that second carriage C-B can also ride laterally, toward and away from first carriage C-A. An electrically controlled carriage linear actuator 160 propels the first and second carriages C-A and C-B toward and away from each other along the rail channels 132, and in turn move the first roller set A and second roller set B toward and away from each other. This function, too, is preferably controlled through operation of a computer (not shown).

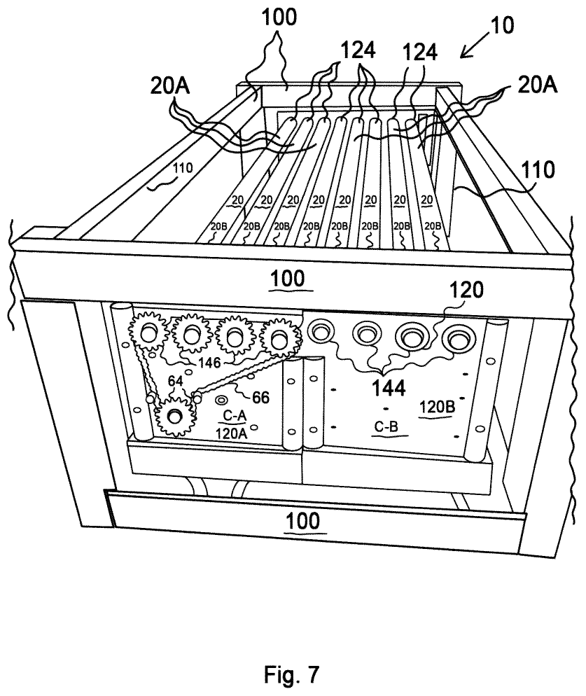

With regard to control of these and other bed 10 functions, it is noted that the rotational speed of the rollers 20 can be changed using a remote control. Floor nurses need to select proper roller 10 rotation speeds prescribed by the physician for a specific patient, based on his or her medical condition. The bed 10 also can function as many existing hospital beds in terms of bending (head up, and down, legs up and down, or both) and raising up or lowering to the proper levels as shown in FIG. 7 in the Appendix attached to the provisional application from which this application continues.

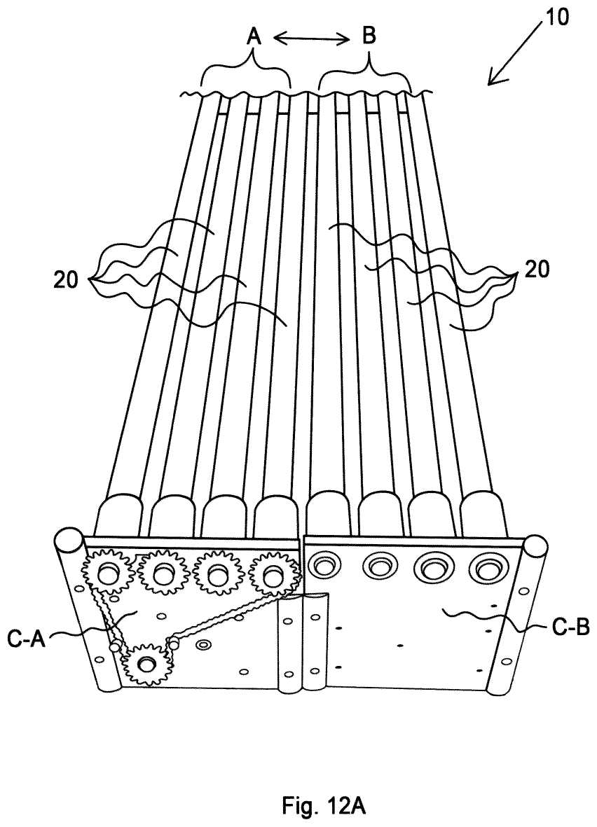

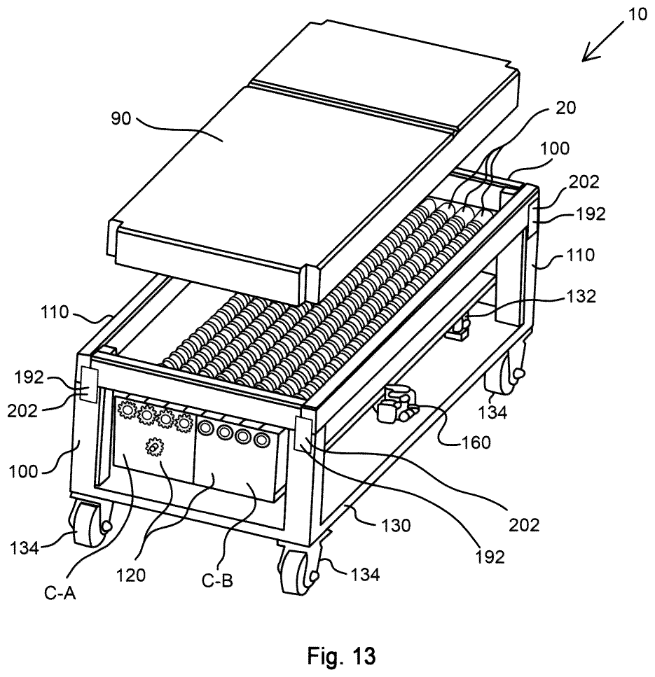

An additional, preferred feature is a weight measuring mattress elevating assembly 170 which detects the weight of each patient and compensates for weight differences among patients by raising or lowering the mattress 90 relative to rollers 20 a distance corresponding to the weight detected, so that the radial protrusions 22 apply similar and appropriate levels of pressure or force against the body of the patient regardless of their weight. See FIGS. 13-19. Without this inventive feature, the radial protrusions 22 might in some instances bear with excessive force against the body of a heavier patient and cause bruising, or bear with insufficient force a against the body of a lighter patient, and therefore fail to fully perform their pressure shifting function.

The weight measuring mattress elevation assembly 170 has three basic parts: a mattress assembly 180, a mattress linear actuator system 190, and a weight sensing system 200 including load sensors 202. The weight sensing system 200 measures the weight of the patent resting on the mattress 90, activates the mattress linear actuator system 190. When the patient lies on the mattress 90, a weight sensor also referred to herein as a load sensor 202 sends the weight measurement to the microcontroller and the mattress linear actuator system 190 moves the mattress assembly 180 up or down. It is noted that a load sensor 202 is located on the base of the top of the linear actuator 192 where the sliding part connects to the mattress frame. Thus the weight sensing system 200 raises or lowers the mattress assembly 180 as needed to produce optimum roller and radial protrusion 22 pressure against the patient body.

The mattress linear actuator system 190 preferably includes first, second, third and fourth built-in load cell linear actuators 192 each including a motor M and pump PP fixedly mounted to the roller frame 100 inside the first, second, third and fourth roller frame 100 corners. See FIGS. 13 and 16-18. These linear actuators 192 are interconnected by a linking hydraulic line 190L to form a single mattress linear actuator system 190, thereby forming a loop along the periphery of the roller frame 100, so that the linear actuator 192 operate in unison to raise and lower the mattress assembly 180 the same distance and at the same speed. Each linear actuator 192 includes a cylinder C mounted to the roller frame 100 and an upwardly extending plunger P which supports and bears against the lower surface of each corner of the roller frame 100. A preferred linear actuator 192 is model HMPB 500 lb series dimensions. Columbus Mckinnon, with Global Headquarters at 205 Crosspoint Parkway Getzville, New York 14068.

The mattress assembly 180 preferably includes a mattress frame 182 extending along the periphery of and underneath the mattress 90 and the mattress shielding sheet 80 below the mattress 90. The mattress assembly 180 also includes security bands 184 extending laterally across the interior of the mattress frame, each security band 184 being formed of low-friction coefficient thermoresistant polymer and used to secure and stabilize the mattress 90 within roller frame 100. The moving head of each linear actuator 192 is mounted securely to the inner aspect of the roller frame 100. The base of the linear actuator 192 is seated and mounted on the roller frame 100. It is noted that the bed frame A moves up and down within the proper stroke length controlled by the bed's central control system which includes a microcontroller.

As noted, the weight measuring and mattress elevation assembly 170 detects the weight of each patient and raises the mattress shielding sheet 80 and mattress 90 for heavier patients so that the radial protrusions 22 provide optimum rather than not excessive force. By the same token, the mattress linear actuator system 190 lowers the mattress shielding sheet 80 and mattress 90 for lighter patients so that the radial protrusions 22 provide optimum rather than inadequate force.

The weight sensing system 200 preferably includes a load sensor 202 connected to each linear actuator 192 and a microprocessor (not shown) attached at the bottom of the bed and connected to a switch operating the connected linear actuator pump PP and pump motor M. A program is stored in the microprocessor, which converts the weight detected by the load sensor 202 to a signal activating the hydraulic pump PP to propel hydraulic fluid flow in one direction for a heavier patient, thereby raising the mattress assembly 180, or in the opposite direction for a lighter patient, thereby lowering the mattress assembly 180, for a length of time selected by the program to raise or lower the mattress assembly 180 a distance corresponding to the weight detected of the particular patient resting on the mattress 90.

An example of a suitable load sensor 202 is a load cell sensor CLP/62 kN—closed loop, manufactured by PACELINE™. More specifically, a load cell or load sensor 202 is an electronic device that converts tension or compression forces into a corresponding electrical signal. Each linear actuator 192 has load sensor 202 the form of a CLP/62 kN load sensor 202 that senses the patient weight and sends an electrical signal to the bed microcontroller to lower or raise the mattress assembly 180 to maintain the proper contact pressure between the patient and rollers 20 and their radial protrusions 22. A load sensor 202 is mounted on top of the plunger P of each mattress linear actuator 192 to so that the mattress frame 182, mattress 90 and patient all rest on the four load sensors 202 and linear actuators 192, as shown in the attached drawings.

While the invention has been described, disclosed, illustrated and shown in various terms or certain embodiments or modifications which it has assumed in practice, the scope of the invention is not intended to be, nor should it be deemed to be, limited thereby and such other modifications or embodiments as may be suggested by the teachings herein are particularly reserved especially as they fall within the breadth and scope of the claims here appended.

I claim as my invention:

1. An alternating pressure bed, comprising:
a mattress and a mechanism for continually varying the relative level of pressure of the mattress against a person lying on the mattress from one region of contact to another, to prevent prolonged high pressure against fixed areas that can hinder blood circulation and lead to ailments such as pressure sores
wherein the bed includes first and second sets of closely spaced rollers mounted in a roller frame to be mutually parallel and co-planar along a preferably horizontal plane and each rotatable about its individual longitudinal axis, and a first drive mechanism for rotating each of the rollers in the first set in a clockwise direction and a second drive mechanism for rotating each of the rollers in the second set in a counter-clockwise direction, and wherein a mattress shielding sheet extends across and rests on the rollers, and a mattress extends across and rests on the mattress shielding sheet, and each said roller has at least one surface protrusion, such that when the roller is rotated the protrusion applies alternating and varying upward pressure against the mattress shielding sheet and therefore against the mattress and a person resting on the mattress.
